(19) United States
(12) Patent Application Publication
(10) Pub. No.: US 2026/0088311 A1
(43) Pub. Date: Mar. 26, 2026

(54) Low-Oxygen Facilities and Operating Thermal Batteries in Such Facilities

(71) Applicant: Fourth Power, Inc., Cambridge, MA (US)

(72) Inventors: Asegun Henry, Hyde Park, MA (US); Michael Hvasta, Lawrence Township, NJ (US); Colin Clancy Kelsall, Cambridge, MA (US); Sandeep Pidaparti, Burlington, MA (US); Tyler Young, Boston, MA (US)

(21) Appl. No.: 18/897,956

(22) Filed: Sep. 26, 2024

(51) Int. Cl. H01M 6/50; H01M 6/36

(52) U.S. Cl. CPC H01M 6/5072; H01M 6/36; H01M 6/5038

(57) ABSTRACT

Described herein are energy storage systems comprising battery units and low-oxygen enclosure units that form enclosed environments around the battery units. Also described are methods of operating such energy storage systems such as achieving and maintaining low oxygen concentrations in the enclosure units (e.g., less than 100 ppm) and other conditions (e.g., moisture, temperatures) while supporting battery unit operations (e.g., heat dissipation, degassing). An enclosed environment may have a volume of at least 50 m³, sufficient for a battery unit with a capacity of at least 1 MWh. In addition to environment purging capabilities, the enclosure unit comprises an oxygen-getter unit (e.g., molten media) which allows to reduce the number of purging cycles and addresses possible oxygen ingress (e.g., through the enclosure walls and/or outgassing). In some examples, the enclosure unit provides efficient heat dissipation to the external environment by reducing insulation/enhancing heat transfer through the enclosure walls.

### BACKGROUND

Energy storage systems are essential for managing the supply and demand of electricity, improving grid stability, and enabling the integration of renewable energy sources. Various types of energy storage systems have been proposed and adopted for various applications, such as electrochemical energy storage systems (e.g., lithium-ion batteries) and thermal energy storage systems. Specifically, lithium-ion batteries provide high energy density and high efficiency but are expensive and susceptible to thermal runaway (e.g., in which flammable electrolytes and other components may burn in the presence of oxygen). Thermal batteries can use molten materials (e.g., salts, oxides/glasses, metalloids, metals) to transfer and store thermal energy at high temperatures (e.g., more than 1000° C.), which can be used to generate electricity (e.g., using thermophotovoltaics (TPVs), turbines) or can be used to provide thermal energy (e.g., for industrial applications). It should be noted that it is often desirable to operate TPV systems or, more specifically, TPV emitters at very high temperatures, e.g., above 1000° C., above 1500° C., or even above 1900° C. The total power radiated per unit area of a TPV emitter (“blackbody” in Stefan-Boltzmann Law) is proportional to the fourth power of the temperature P∝T⁴. Thus, higher temperatures lead to significantly higher radiative power. Higher temperatures also shift the peak of the emitted spectrum towards shorter wavelengths (per Wien's Displacement Law). This shift is more suitable for photovoltaic conversion if the bandgap of the TPV cells (on a TPV receiver) is appropriately matched thereby maximizing the absorption and conversion efficiency, which may be as high as 30% and even beyond 50%.

Combustible materials, high temperatures, and/or other factors make it intractable to operate such energy storage systems in the ambient environment for extended periods (i.e., months to years) because the atmosphere contains oxygen. While various systems (e.g., food storage, glove boxes) have attempted to reduce the oxygen content in their operating environments, these systems are either small in size (e.g., less than 10 m³) and not suitable for large-scale energy storage systems or have rather high oxygen content (e.g., greater than or equal to 1%, which is 10,000 ppm). Achieving and maintaining low oxygen content (e.g., less than 500 ppm) at large scales (e.g., at least 50 m³) is extremely challenging. Getting to the low oxygen partial pressures needed for extended operation (e.g., <10 ppm) would therefore require a process far beyond conventional purging. Adding the cost of a purge gas, difficulties in achieving high purging efficiencies, outgassing of various structures (especially hot surfaces), and difficulties of sealing large surfaces with pass-throughs and entry points, relying on a purge system alone becomes an extreme challenge and not cost-effective for large-scale facilities.

What is needed are energy storage systems comprising low-oxygen enclosure units that have a large scale (e.g., at least 50 m³) and are capable of achieving and maintaining low oxygen concentrations (e.g., less than 10 ppm) while housing various types of battery units (e.g., thermal batteries, lithium-ion batteries) or any technologies that make use of materials that could oxidize or degrade in air, and supporting operating conditions of these systems (e.g., heat dissipation).

### SUMMARY

Described herein are energy storage systems comprising battery units and low-oxygen enclosure units that form enclosed environments around the batteries. Also described are methods of operating such energy storage systems such as achieving and maintaining low oxygen concentrations in the enclosure units (e.g., less than 10 ppm) and other conditions (e.g., moisture, temperatures) while supporting battery unit operations (e.g., heat dissipation, degassing). An enclosed environment may have a volume of at least 50 m³, sufficient for a battery unit with a capacity of at least 1 MWh. In addition to environment purging capabilities, the enclosure unit comprises an oxygen-getter unit (e.g., gas, liquid, or solid oxidizable media) which reduces the number of purging cycles required and addresses possible oxygen ingress (e.g., through the enclosure walls and/or outgassing). In some examples, the enclosure unit provides efficient heat dissipation to the external environment by reducing insulation/enhancing heat transfer through the enclosure walls.
Clause 1. An energy storage system comprising: a battery unit, which has a total energy-storage capacity of at least 1 MWh; and a low-oxygen enclosure unit, which forms an enclosed environment that is fluidically isolated from an external environment by the low-oxygen enclosure unit during operation of the battery unit, wherein: the enclosed environment has a volume of at least 50 m3 and surrounds the battery unit while an oxygen concentration in the enclosed environment is less than 500 ppm during the operation of the battery unit, and the low-oxygen enclosure unit comprises an oxygen-getter unit of one or more types selected from the group consisting of a molten-media oxygen-getter unit, a solid-based oxygen-getter unit, and a gas-based oxygen-getter unit.
Clause 2. The energy storage system of clause 1, wherein the oxygen-getter unit is the molten-media oxygen-getter unit comprising one or more elements selected from the group consisting of magnesium, tin, zirconium, titanium, iron, aluminum, zinc, and silicon that form a molten media during the operation of the battery unit.
Clause 3. The energy storage system of clause 2, wherein the molten media is configured to operate at a temperature of 500-2000° C. during the operation of the battery unit.
Clause 4. The energy storage system of clause 2, wherein the oxygen-getter unit further comprises a gas delivery component comprising a porous core and a non-porous shell formed from one or more materials selected from the group consisting of ceramic and carbon.
Clause 5. The energy storage system of clause 2, wherein the low-oxygen enclosure unit comprises an exterior wall separating the enclosed environment from the external environment comprising a passthrough for accessing the oxygen-getter unit from the external environment.
Clause 6. The energy storage system of clause 5, wherein the low-oxygen enclosure unit comprises an oxygen-getter enclosure configured to controllably isolate a local environment surrounding the oxygen-getter unit from a remaining portion of the enclosed environment.
Clause 7. The energy storage system of clause 1, wherein the low-oxygen enclosure unit comprises one or more additional oxygen-getter units positioned in different parts of the enclosed environment and away from the oxygen-getter unit.
Clause 8. The energy storage system of clause 1, wherein: the low-oxygen enclosure unit comprises an exterior wall separating the enclosed environment from the external environment, the exterior wall comprises a metal sheet or a polymer sheet forming both an interior wall surface and an exterior wall surface, the interior wall surface faces and is exposed to the enclosed environment, and the exterior wall surface faces and is exposed to the external environment.
Clause 9. The energy storage system of clause 1, wherein the low-oxygen enclosure unit comprises a partitioning wall, which is configured to fluidically isolate a first section of the low-oxygen enclosure unit from a second section of the low-oxygen enclosure unit.
Clause 10. The energy storage system of clause 1, wherein the low-oxygen enclosure unit comprises an electrochemical-oxygen sensor for determining the oxygen concentration of the enclosed environment.
Clause 11. The energy storage system of clause 1, wherein the low-oxygen enclosure unit comprises a dehumidifier for removing moisture from the enclosed environment generated while heating the battery unit.
Clause 12. The energy storage system of clause 1, wherein the low-oxygen enclosure unit comprises an oxygen-blocking cover suspended above the battery unit and configured to drop and conform to the battery unit when released.
Clause 13. The energy storage system of clause 1, wherein the low-oxygen enclosure unit comprises an internal pressurization unit configured to maintain the enclosed environment at a higher pressure than the external environment.
Clause 14. The energy storage system of clause 13, wherein the internal pressurization unit is configured to supply inert gas to the enclosed environment based on a pressure difference between the enclosed environment and the external environment.
Clause 15. The energy storage system of clause 14, wherein the inert gas is selected from the group consisting of nitrogen, argon, neon, helium, xenon, and krypton.
Clause 16. The energy storage system of clause 1, further comprising an external liquid cooling system positioned in the external environment and comprising a set of pipes protruding through and into the low-oxygen enclosure unit and thermally coupled to the battery unit.
Clause 17. The energy storage system of clause 1, wherein the battery unit is a thermal battery comprising a battery core and a battery insulation surrounding the battery core and thermally isolating the battery core from the enclosed environment such that the battery core is configured to operate at a temperature of at least 1000° C.
Clause 18. The energy storage system of clause 17, wherein the battery core further comprises a storage unit, a piping infrastructure, and a power block such that the piping infrastructure is configured to pump a molten metal between the storage unit and the power block.
Clause 19. The energy storage system of clause 17, wherein the battery core is configured to operate at a temperature of at least 1000° C.
Clause 20. A method of operating an energy storage system comprising a battery unit and a low-oxygen enclosure unit surrounding the battery unit and comprising an oxygen-getter unit, the method comprising: flowing an inert gas into the low-oxygen enclosure unit until an oxygen concentration in the low-oxygen enclosure unit falls below a first threshold, wherein the low-oxygen enclosure unit forms an enclosed environment separated by the low-oxygen enclosure unit from an external environment such that the battery unit is positioned with the enclosed environment; activating the oxygen-getter unit thereby further reducing the oxygen concentration in the low-oxygen enclosure unit below a second threshold, lower than the first threshold and lower than 500 ppm; and operating the battery unit while the oxygen concentration in the low-oxygen enclosure unit is maintained below the second threshold.
Clause 21. The method of clause 20, wherein the inert gas is argon.
Clause 22. The method of clause 20, wherein activating the oxygen-getter unit comprises: melting a media comprising one or more elements selected from the group consisting of magnesium, tin, zirconium, titanium, iron, aluminum, zinc, and silicon thereby forming a molten media, and flowing a gas contained in the low-oxygen enclosure unit and surrounding the battery unit through the molten media.
Clause 23. The method of clause 20, further comprising partitioning out a first section of the low-oxygen enclosure unit from a second section of the low-oxygen enclosure unit, wherein the battery unit comprises a first battery subunit positioned in the first section and a second battery subunit positioned in the second section.
Clause 24. The method of clause 23, further comprising, after partitioning out the first section, fluidically coupling the first section with the external environment.
Clause 25. The method of clause 24, further comprising, prior to fluidically coupling the first section with the external environment, shutting down the first battery subunit.
Clause 26. The method of clause 24, wherein the second battery subunit continues to operate while the first section is fluidically coupled with the external environment.
Clause 27. The method of clause 20, wherein: low-oxygen enclosure unit comprises an exterior wall separating the enclosed environment from the external environment, and operating the battery unit inside the low-oxygen enclosure unit comprises dissipating heat through the walls of the low-oxygen enclosure unit from the enclosed environment to the external environment.
Clause 28. The method of clause 20, wherein operating the battery unit inside the low-oxygen enclosure unit comprises removing moisture from the enclosed environment.

These and other embodiments are described further below with reference to the figures.

### BRIEF DESCRIPTION OF THE DRAWINGS

The included drawings are for illustrative purposes and serve only to provide examples of possible structures and operations for the disclosed inventive systems, apparatus, and methods. These drawings in no way limit any changes in form and detail that may be made by one skilled in the art without departing from the spirit and scope of the disclosed implementations.

FIG. 1 is a schematic cross-sectional view of an energy storage system comprising a battery unit and a low-oxygen enclosure unit forming an enclosed environment around the battery unit, in accordance with some examples.

FIGS. 2A and 2B are schematic views of a battery unit in the form of a thermal battery, in accordance with some examples.

FIG. 3 is a schematic cross-sectional view of a wall of the low-oxygen enclosure unit, in accordance with some examples.

FIGS. 4A and 4B are schematic views of an oxygen-getter unit of a low-oxygen enclosure, in accordance with some examples.

FIG. 4C is a schematic cross-sectional view of an energy storage system illustrating a passthrough for replacing the media in the oxygen-getter unit, in accordance with some examples.

FIGS. 5A and 5B are schematic side and top cross-sectional views of a partitioning wall in a low-oxygen enclosure, in accordance with some examples.

FIGS. 6A and 6B are schematic cross-sectional views of the low-oxygen enclosure unit before and after deploying a fire blanket to cover the battery unit, in accordance with some examples.

FIG. 7 is a process flowchart corresponding to a method of operating an energy storage system comprising a battery unit and a low-oxygen enclosure unit forming an enclosed environment around the battery unit, in accordance with some examples.

### DETAILED DESCRIPTION

### Introduction

As noted above, energy storage systems often include various materials (e.g., electrolytes, lithium metal, refractory materials, molten metals, graphite) that are susceptible to oxidation (e.g., can cause fires in extreme cases). Furthermore, many energy storage systems (e.g., thermal batteries) can operate at high temperatures, which greatly increases oxidation kinetics. Finally, some systems (e.g., grid storage) tend to aggregate large amounts of such materials at the same location to increase energy and power density, thereby increasing the safety risks. All of these factors present various challenges for designing, constructing, and operating energy storage systems.

Described herein are energy storage systems comprising battery units positioned within low-oxygen enclosure units that isolate these battery units from the ambient environment and, more specifically, from the high oxygen content in ambient environments. For purposes of this disclosure, a “low oxygen content” is defined as a content of less than 500 ppm by volume, while a “high oxygen content” is defined as a content of at least 5000 ppm (or 0.5%) by mole fraction/molar concentration. As a reference, air typically contains about 21% molar of oxygen. A fruit and vegetable warehouse typically contains about 1-3% of oxygen. Both of these references are examples of high oxygen content environments, which are not suitable for operations of some types of batteries (e.g., thermal batteries and the like).

Furthermore, low-oxygen enclosures described herein may have a volume of at least 50 m³ or even at least 75 m³ and may be referred to as “large volume enclosures” to differentiate from small-volume enclosures, which are defined here as enclosures of less than 10 m³. Some examples of small-volume enclosures include glove boxes, semiconductor processing enclosures, and the like.

A low-oxygen enclosure unit may be formed using metal or plastic sheets without or with insulation (e.g., positioned on the interior or exterior sides of these sheets). In some examples, the walls of the low-oxygen enclosure unit may be relied on to dissipate the heat to the environment. For example, a thermal battery may have an internal storage medium temperature exceeding 1900° C. While the internal components are heavily insulated and liquid cooling may provided to various intermediary components, substantial amounts of heat may dissipate into the enclosed environment around the battery unit. As an example, out of 1 MW of heat leakage, 90-95% may be captured by liquid cooling while the remaining 5-10% (or 50-100 kW) may dissipate into the enclosed environment. This dissipated heat may be removed by one or both of (1) heat transfer through the walls of the low-oxygen enclosure unit when the temperature of the enclosed environment exceeds that of the external/ambient environment and (2) an airconditioning unit/chiller(which may be also operable as a dehumidifier).

In some examples, some insulation may be used when the energy storage system is operated in particularly hot environments (e.g., greater than +40° C. ambient, high sun intensity) and/or particular cold environments (e.g., below −20° C.). Specifically, insulation can help to decouple the control system's performance parameters from the seasonal/environmental variations. For example, a low-oxygen enclosure unit may include a chiller for keeping the internal environment at a set temperature range (e.g., to counter any thermal leaks from the battery unit). If the enclosure unit walls are not insulated, the walls may experience some significant thermal expansion and contraction with the seasons/time of day that can impact the sealing performance. For example, the seals may be more leaky in the summer when the walls and other structures everything expands. The insulation may help to dampen these temperature fluctuations and preserve the seals without overloading the control system/chiller.

In some examples, polymer-based seals are used for sealing the seams between adjacent sheets in order to prevent oxygen penetration into the low-oxygen enclosure unit. Such polymer seals may be mechanically affixed on the inner side of the vessel, such that the sealing face can be slightly pressurized from the inside. A slight pressurization (e.g., at least 50 Pa or even at least 100 Pa) enhances sealing interfaces and prevents the inflow of ambient air through any leak paths. For example, an overlapping tape with a cured sealant between the tape and the walls may be used between sheets.

During the operation, a low-oxygen enclosure unit is initially purged with an inert gas (e.g., nitrogen (N₂), argon (Ar), and/or helium (He)) to drop the initial concentration (from 20%+in the air) to less than 1% molar or even less than 0.1% molar. A single purge or multiple purges (e.g., 2, 3, or more) may be used. Various aspects can be used to minimize gas mixing while purging. For example, inlets and outlets may be positioned in opposite corners of the enclosure unit with the vertical position determined by the density of the purging gas (relative to the density of the gas being displaced). For example, argon is heavier than air, in which case the purging inlet can be positioned at the bottom of the enclosure unit while the purging outlet can be positioned at the top. On the other hand, if purging with helium, the purging outlet can be positioned at the top of the enclosure unit while the purging inlet can be positioned at the top.

In addition to the enclosed environment purging capabilities, the low-oxygen enclosure unit comprises an oxygen-getter unit which allows for a reduction of the number of purging cycles and addresses possible oxygen ingress (e.g., through the enclosure walls and/or outgassing). This may be referred to as a multi-stage oxygen reduction in the enclosure unit. The multi-stage oxygen reduction should be distinguished from multiple purging cycles and requires at least two different oxygen reduction methods, e.g., purging and using an oxygen-getter unit. It should be noted that the same low-oxygen enclosure unit may include multiple oxygen-getter units positioned throughout the enclosure unit, e.g., in different sections of the enclosure unit that are separable by partition walls (as further described below). Furthermore, in some examples, the individual getter units may be positioned within a locker so that the getter charge materials can be changed out easily without having to shut down the entire enclosure. In these examples, when a getter needs to be recharged, the locker can be closed, which will close off the getter to the enclosure's environment, and the getter can be shut down. As a result, a much smaller locker volume can then be accessed (e.g., have another door) from the outside air environment, e.g., for a person or machine automatically emptying the used (e.g., oxidized) getter material, and replace it with fresh (e.g., un-oxidized) material. Once the getter recharging process is completed, the outer door can be closed and the locker can be purged with inert gas, followed by opening of the locker back to the enclosure gas environment for continued gettering. Such individual lockers eliminate the need for purging the entire enclosure unit, which may have a volume 100 times or greater than each locker.

In some examples, the same or another getter type is used for removing other (non-oxygen) components from the environment of the enclosure unit. For example, the operation of a battery unit (especially at such high temperatures, e.g., exceeding 1000° C.) may cause outgassing of various components and/or reactions that generate volatile components.

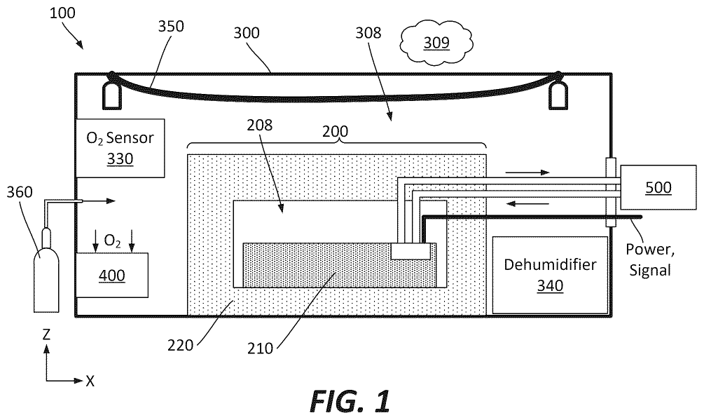

### FIG. 1: Examples of Energy Storage System

FIG. 1 is a schematic cross-sectional view of an energy storage system 100 comprising a battery unit 200 and a low-oxygen enclosure unit 300 forming an enclosed environment 308 around the battery unit 200 thereby separating the battery unit 200 from an external environment 309, in accordance with some examples. For example, the external environment 309 may contain oxygen, moisture/water, and/or other components undesirable for the operation of the battery unit 200.

In some examples, a battery unit 200 has an energy-storage capacity of at least 1 MWh or even at least 10 MWh (thereby differentiating the low-oxygen enclosure unit 300 from various battery cell testing and fabrication facilities, e.g., glove boxes, as well as battery pack enclosures). Using/combining such high levels of energy-storage capacities is generally not practical for any applications other than stationary energy storage (e.g., grid balancing, industrial support). The energy may be stored in various forms, e.g., thermal, electrochemical, and other types. As such, various types of battery units 200 are within the scope, e.g., a thermal battery, a lithium-ion battery, a lithium-metal battery, and the like. Overall, any batteries, energy conversion systems, or chemical conversion/reactor systems involving molten salts, molten metals, alkali metals, molten glass, molten semiconductors, ceramics polymers, or combustible materials are within the scope.

Different types of batteries may have different requirements for the external environment 309. However, most types benefit from a low oxygen content in their operating environments, e.g., to preserve the integrity of the operating components/prevent oxidation, safety/prevent fire, and the like. For example, a thermal battery may utilize various materials (e.g., graphite, tin) that are maintained at high temperatures (e.g., at least 1000° C.), which may trigger rapid oxidation if exposed to high-oxygen content (O₂) and/or high-moisture (H₂O) content, which is present in ambient air. Furthermore, some types of these batteries (e.g., thermal batteries, lithium-ion batteries arranged into megapack) require large facilities (e.g., at least 50 m³) to provide efficient energy and power. Specifically, thermal batteries utilize complex infrastructure (e.g., thermal insulation) and equipment that is practical at large scales. As a reference, a standard 40-foot shipping container has a volume is 67.3 m³.

Referring to FIG. 1, the low-oxygen enclosure unit 300 forms an enclosed environment 308 that is fluidically isolated from an external environment 309 during the operation of the battery unit 200. The fluidic isolation is achieved by the wall of the low-oxygen enclosure unit 300 and various passthroughs (e.g., to bring in and out fluids as well as power, camera feeds, sensor signals, control signals, to change the media in oxygen-getter units) formed in the walls as further described below. It should be noted that fluidic isolation allows for minor unsealed openings in the walls such that the total cross-section of such openings represents less than 0.01% of the total wall surface. The air ingress from any such unsealed openings may be addressed by operating the low-oxygen enclosure unit 300 as well as maintaining a positive pressure (e.g., the enclosed environment 308 having a pressure at least 50 Pa or even at least 100 Pa greater than the pressure of the external environment 309) thereby reducing the ingress of oxygen and/or other undesirable components through such openings/leak paths.

In some examples, the enclosed environment 308 has a volume of at least 50 m³ or, more specifically, at least 200 m³ or even at least 500 m³. As noted above, such a large size is needed to ensure various types of battery units 200. However, it is challenging to achieve and maintain a low oxygen concentration in such large spaces. In some examples, the oxygen concentration in the enclosed environment 308 is less than 500 ppm during the operation of the battery unit 200 or even less than 100 ppm or even less than 10 ppm. First, large volumes require significant amounts of purge gases. Second, such low oxygen concentrations require multiple purge cycles with significant levels of removal of previous gases and intermixing prevention. At the same time, significant removal in such large structures is challenging due to potential pressure differentials between the external environment 309 and the enclosed environment 308 and also due to high vacuuming costs. Instead, such low oxygen concentrations are achieved by utilizing one or more oxygen-getter units 400 that bring the oxygen concentration below the level that is economically feasible with conventional purging.

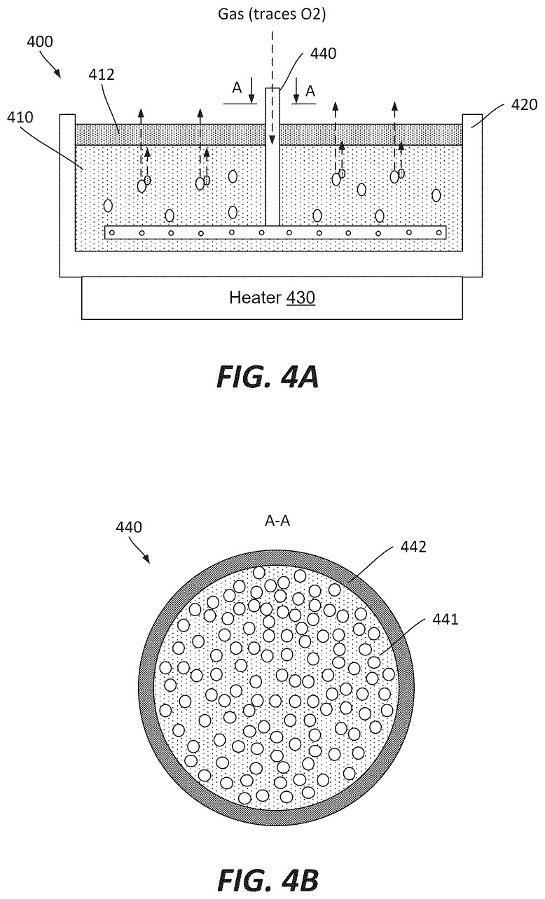

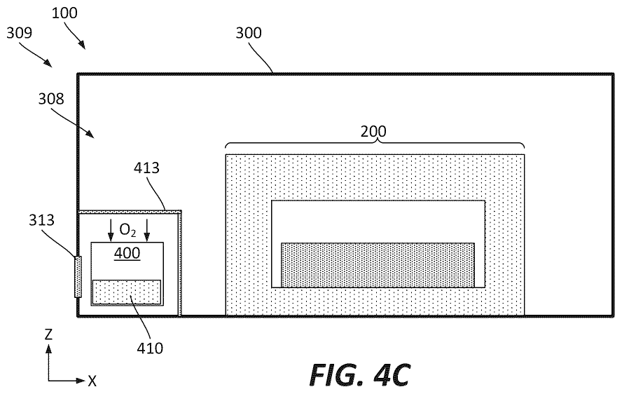

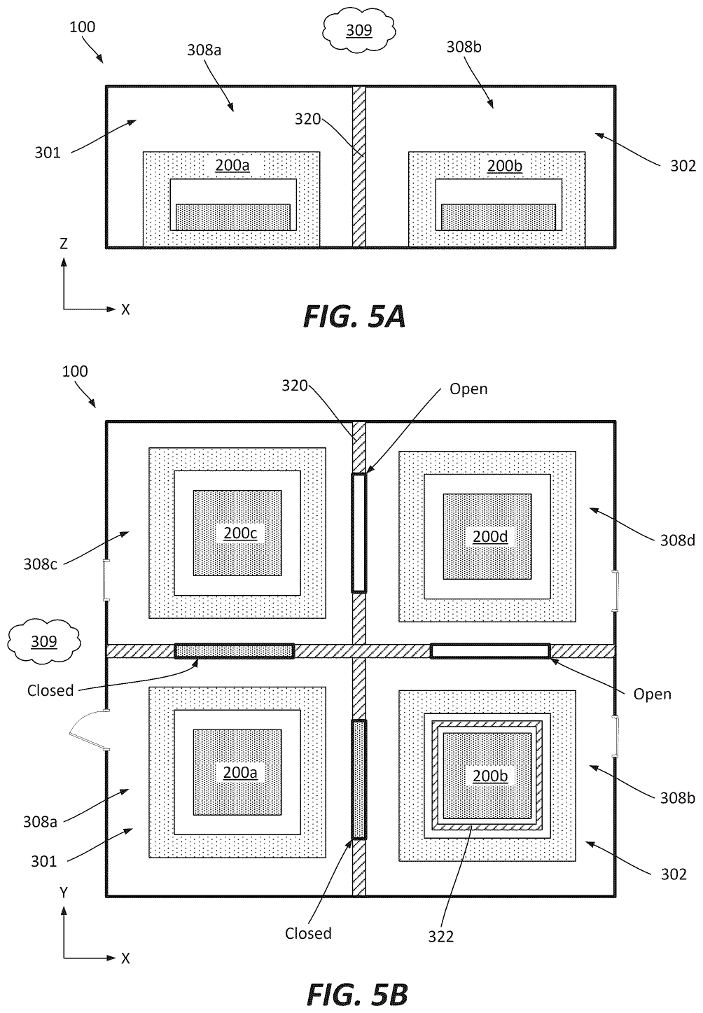

It should be noted that a section of the low-oxygen enclosure unit 300 may be partitioned off and open to the external environment 309 (as further described below with reference to FIG. 4A and FIGS. 5A-5B), while the remaining section of the low-oxygen enclosure unit 300 still forms the enclosed environment 308. The partitioning can be used to access certain components of the energy storage system 100 (e.g., an oxygen-getter unit 400, a battery unit 200) without the need to remove oxygen (using purging and oxygen getting) in the entire enclosed environment 308.

In some examples, the low-oxygen enclosure unit 300 comprises one or more oxygen-getter units 400. For example, a separate low-oxygen enclosure unit 300 is provided in each section of the low-oxygen enclosure unit 300 that can be partitioned off from all adjacent sections. Furthermore, multiple oxygen-getter units 400 allow taking one or more offline (e.g., to replace the depleted media) while the remaining ones can continue to remove oxygen from the enclosed environment 308. Various types of oxygen-getter units 400 are within the scope of the scope, such as a molten-media oxygen-getter unit, a solid-based oxygen-getter unit, and a gas-based oxygen-getter unit. Additional aspects of the oxygen-getter unit 400 are described below with reference to FIGS. 4A-4B. The getter units may also incorporate large fans, blowers or compressors to circulate large volumes of the gas contained within the enclosure quickly thereby accelerating the time frame in which a low oxygen pressure environment can be achieved.

In some examples, the same oxygen-getter unit 400 or other types of getter units may be used to remove other (non-oxygen) components from the environment of low-oxygen enclosure unit 300. Some examples of these components include nitrogen-containing molecules such as ammonia, nitric oxide (NOx), cyanides, or other nitrogen complexes. For example, aldehydes and ketones may be used as getters for some of these materials.

In some examples, the low-oxygen enclosure unit 300 comprises an electrochemical-oxygen sensor 330 for determining the oxygen concentration of the enclosed environment. Some specific examples of electrochemical oxygen sensors include, but are not limited to, galvanic oxygen sensors and polarographic oxygen sensors. Other types of oxygen sensors include optical oxygen sensors (e.g., measuring changes in fluorescence or phosphorescence), paramagnetic oxygen sensors, and zirconia oxygen sensors. The output of the oxygen sensor may be used to initiate the operation of the battery unit 200 (e.g., heat up the battery unit 200 to its operating temperature when the oxygen concentration drops below an operating threshold). In some examples, the battery unit 200 may have different oxygen concentration thresholds (e.g., corresponding to different operating temperatures of a thermal battery). As such, the output of the oxygen sensor may be used to modulate the operation of a battery unit 200, e.g., to switch from one operating mode to another operating mode.

In some examples, the low-oxygen enclosure unit 300 comprises a dehumidifier 340 or a water sorbent, for removing moisture from the enclosed environment generated while heating the battery unit 200. For example, various components of the battery unit 200 (e.g., battery insulation 220) may release a significant amount of water while being heated. In more specific examples, each section of the low-oxygen enclosure unit 300 that can be partitioned off from the rest of the low-oxygen enclosure unit 300 can be equipped with its own dedicated dehumidifier 340. Furthermore, a dehumidifier 340 may be used as an air-conditioning, e.g., to remove excess heat from the low-oxygen enclosure unit 300 (e.g., the heat released from the battery unit 200 during its operation).

In some examples, the low-oxygen enclosure unit 300 comprises an internal pressurization unit 360 configured to maintain the enclosed environment 308 at a higher pressure than the external environment 309 (e.g., at least 50 Pa higher or even at least 100 Pa higher). As noted above, a higher internal pressure of the low-oxygen enclosure unit 300 allows to minimize or even completely avoid any ingress of the ambient air into the enclosed environment 308 thereby preserving the low oxygen concentration of the enclosed environment 308. For example, the bulk fluid velocity through any pores or leak paths may be greater than the diffusional velocity associated with oxygen, nitrogen, or any other molecule contained in the outside gas atmosphere from diffusing against its concentration gradient into the enclosure. This can be achieved with a small (e.g., 10-100 Pa) overpressure, since diffusional velocities at room temperature tend to be far less than 0.1 m/s, and 100 Pa can easily create velocities on the order of 0.1 m/s in leak paths. For example, the internal pressurization unit 360 is configured to supply an inert gas (e.g., argon) to the enclosed environment 308 based on the pressure difference between the enclosed environment 308 and the external environment 309. The enclosed environment 308 may be also referred to as an internal environment. The internal pressurization unit 360 may be controlled using a pressure sensor.

In some examples, the energy storage system 100 further comprises an external liquid cooling system 500 positioned in the external environment 309. The external liquid cooling system 500 may comprise a set of pipes protruding through and into the low-oxygen enclosure unit 300 and thermally coupled to the battery unit 200. The liquid cooling system 500 may pump the cooling liquid (e.g., oil) through the battery unit 200 (e.g., parts of the battery insulation 220, a TPV unit, and the like). The cooling liquid is then cooled externally (e.g., using ambient air). In some examples, the external liquid cooling system 500 is configured to remove at least 1 MW of heat from various components in the enclosed environment 308 (or, more specifically, from the battery unit 200) or even 100 MW. In some examples, the energy storage system 100 may be configured to store and deliver thermal energy (e.g., for industrial use). In the same or other examples, the energy storage system 100 may be configured to deliver electric energy.

In some examples, the low-oxygen enclosure unit 300 is partitioned such that different partitions contain/preserve different environments (e.g., one partition filled with argon (Ar), another partition filled with helium (He), yet another partition filled with krypton (Kr) or even xenon (Xe)). Different gases may be used to provide different operating environments and enable different processes. For example, helium (He) can help to limit arcing in high-temperature heaters. Krypton (Kr) and/or xenon (Xe) can help to reduce thermal conductivity and, therefore, the heat loss in the TPV power block or otherwise.

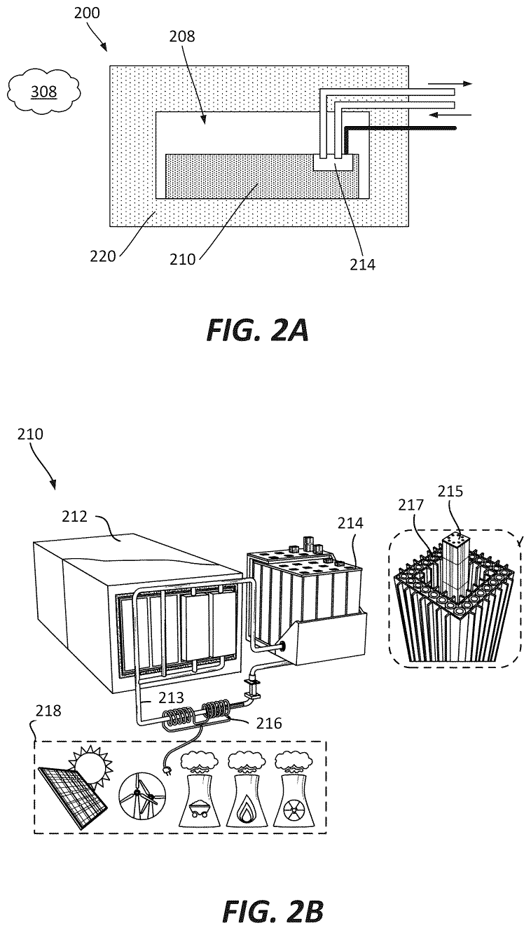

### FIGS. 2a and 2b: Examples of Thermal Battery Systems

FIGS. 2A and 2B are schematic views of a battery unit 200 in the form of a thermal battery, in accordance with some examples. More specifically, a thermal battery may comprise a battery core 210 and a battery insulation 220 surrounding the battery core 210 and thermally isolating the battery core 210 from the enclosed environment 308 such that the battery core 210 is configured to operate at a temperature of at least 1000° C., at least 1500° C., or even at least 1900° C. As noted above, a higher temperature increases the energy capacity of a thermal battery and, in some examples increases the efficiency and power density of recovering the stored energy in such batteries.

Referring to FIG. 2B, the battery core 210 comprises a storage unit 212, a piping infrastructure 213, and a power block 214 such that the piping infrastructure 213 is configured to pump a molten metal (e.g., tin) between the storage unit 212 and the power block 214.

The storage unit 212 may be formed from a set of graphite blocks. The size and the number of these blocks determine, at least in part, the thermal capacity of the storage unit 212 and, more generally, of the battery unit 200. For example, the size of storage unit 212 can be 50 -10,000 m³, while the size of each block may be 0.5 - 5 m³. The battery core 210 may also include a heating element 216 that may be configured to heat up and melt the metal in the piping infrastructure 213 (e.g., during the startup of the battery unit 200). Furthermore, the heating element 216 may be used to “charge” storage unit 212 by further heating up the liquid metal and flowing this heated metal through storage unit 212 where the liquid metal is cooled (while remaining in the liquid phase) by transferring the heat to the storage unit 212 (thereby “charging” the storage unit 212 or, more specifically, increasing the temperature of the storage unit 212).

The recovery of the heat from the storage unit 212 may take different forms, e.g., (1) using a power block 214 that converts the heat into electric energy using TPV cells, (2) using a heat engine such as a turbine, (3) transferring heat to another system (e.g., by pumping a molten metal from the battery unit 200 to an external system), and the like. Storing and recovering energy using TPV cells will now be briefly described.

A thermal battery system equipped with TPV cells (as a part of the power block 214) exploits the fact that thermal radiation scales with absolute temperature to the fourth power (P∝T⁴), in order to achieve high power density and consequently low cost. In concept, a thermal battery system may operate by taking in electricity (e.g., from renewables) to power heating elements 216 (e.g., resistive heaters) to the temperature of 1000-3200° C. or, more specifically, 1500-2500° C. The heating elements 216 convert the electricity into extremely high-temperature heat, which is then transferred to a power block 214 using a piping infrastructure 213 (e.g., a plumbing network made of graphite that carries liquid tin). The tin is mechanically pumped by piping infrastructure 213 (forming a circulation loop). When the tin flows adjacent to the heating elements 216, the tin may nominally heat from the incoming lower temperature (e.g., 1900° C.) to an outgoing higher temperature (e.g., 2400°C.). At this higher temperature, the molten tin is then routed to storage unit 212 (e.g., a bank of energy storage blocks (ESBs) made of carbon or graphite). As the liquid metal passes through pipes situated in between gaps between the blocks, the ESBs are heated to the peak temperature to fully charge the thermal battery system. The storage unit 212 (ESBs) are thermally insulated from the surroundings and can hold thermal energy for long periods (i.e., weeks to months) if needed. When electricity is desired back on the grid, the heating elements 216 are turned off, and the liquid metal is used to carry the sensible heat from the storage unit 102 (ESBs) over to TPV power block 214. The TPV power block 214 comprises a radiation device 217 with individual cavities, that have the liquid metal flowing through its walls, which keep the walls hot. The walls emit light that is then absorbed by the TPV receiver 215 or, more specifically, by the TPV cells and produces electricity (e.g., provided back to the grid).

Overall, the power block 214 is equipped with an array of TPV cells. Each TPV cell is configured to convert thermal energy (provided by the storage unit 212) into electricity via the photovoltaic effect. As noted above, the radiation device 217 may comprise a set of pipes for pumping a thermal fluid (e.g., molten tin) thereby heating the radiation device 217 and producing the radiation, which is then converted by the TPV receiver 215 into electricity. In some examples, the TPV receiver 215 may be retracted (or removed) from the cavity in the radiation device 217 and may be referred to as a TPV “stick” because of its aspect ratio as an extended shape.

Other types of battery units 200 are also within the scope, e.g., a thermal battery that utilizes a heat engine equipped with a turbine for converting thermal energy into mechanical work and, in some examples, to electrical energy using a dynamo. Specifically, heating a working fluid produces high-pressure, high-temperature gas, which then expands and passes through a turbine, causing it to rotate and generate mechanical energy. It should be noted that turbines provide high power output relative to size and weight and are very robust (can operate continuously for long periods).

Reducing the concentration of oxygen in the environment allows the use of new high-temperature materials (e.g., refractory metals/alloys, and refractory borides, nitrides, and carbides) for turbine components thereby increasing the heat engine efficiency. These materials are generally not suitable for high-oxygen concentration environments such as air and steam.

Low-oxygen environments are also beneficial for operating electrochemical systems, such as lithium-ion batteries. Operating electrochemical systems like lithium-ion battery packs in low-oxygen environments enhances safety by reducing the risk of combustion and explosions, prevents the oxidation of critical components, improves thermal management, and enhances the chemical stability of the batteries. These benefits collectively contribute to the safer, more reliable, and longer-lasting operation of lithium-ion batteries.

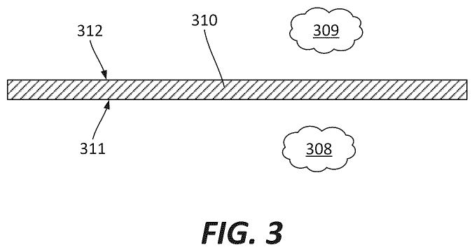

### FIG. 3: Examples of Low-oxygen Facilities

FIG. 3 is a schematic cross-sectional view of an exterior wall 310 of the low-oxygen enclosure unit 300, in accordance with some examples. Specifically, this exterior wall 310 separates the enclosed environment 308 (having a low oxygen concentration) from the external environment 309 (having a high oxygen concentration). As such, the exterior wall 310 should be generally impermeable to at least oxygen. The exterior wall 310 is also able to keep the pressure differential between the enclosed environment 308 and the external environment 309. Finally, the exterior wall 310 may also be able to control the heat flux between the enclosed environment 308 and the external environment 309.

Specifically, the exterior wall 310 may be also relied on to remove the heat from the enclosed environment 308, e.g., to transfer the heat through the exterior wall 310 into the external environment 309. As noted above, the operation of the battery unit 200 may release substantial amounts of heat (e.g., as much as 10 kW or even 1 MW) into the enclosed environment 308. Specifically, the exterior wall 310 has an average heat transfer coefficient of greater than 1 kW/m² or greater than 5 kW/m² thereby enabling this heat release to the environment (outside of the exterior wall 310). It should be noted that additional insulation may be provided around the battery unit 200 (e.g., to reduce the amount of heat escaping to the environment between the exterior wall 310 and the battery unit 200.

In some examples, the exterior wall 310 comprises a metal sheet and/or a polymer sheet forming both an interior wall surface 311 and an exterior wall surface 312, e.g., as shown in FIG. 3. The interior wall surface 311 faces and is exposed to the enclosed environment 308. The exterior wall surface 312 faces and is exposed to the external environment 309. In other words, the exterior wall 310 may not be insulated, at least in some examples. Alternatively, insulation may be positioned over the exterior wall surface 312 and/or over the interior wall surface 311 to reduce the heat transfer through the exterior wall 310.

In some examples, the exterior wall 310 comprises various pass-throughs (e.g., for cooling and electrical lines supporting the operation of the battery unit 200). For example, these pass-throughs can be in the form of metal pipes that are welded to the exterior wall 310. Pass-throughs may be welded to the exterior wall 310 and sealed around the edges (that tend to be cooler). These pass-throughs may be used to provide various cooling options, e.g., remove heat from the battery unit 200 industrial applications using various heating fluids, such as oil (e.g., for food and beverage), carbon dioxide (e.g., cement manufacturing), hydrogen (e.g., for steel manufacturing), and other like fluids.

### FIG. 4a-4c: Oxygen-getter Examples

FIGS. 4A and 4B are schematic views of an oxygen-getter unit 400 of a low-oxygen enclosure unit 300, in accordance with some examples. Various types of oxygen getters are within the scope, e.g., a molten-media oxygen-getter unit, a solid-based oxygen-getter unit, and a gas-based oxygen-getter unit. For example, a molten-media oxygen-getter unit may include one or more elements selected from the group consisting of magnesium, tin, zirconium, titanium, iron, aluminum, zinc, and silicon that form a molten media 410. The terms “oxygen-getter media”, “molten media”, and “media” are used interchangeably. One having ordinary skill in the art would appreciate that the media exists in the molten state when the media is heated during the operation of the oxygen-getter unit 400.

In some examples, in addition to one or more primary oxygen-getting components, a media may also include a solvent (e.g., tin and/or copper) to reduce the melting temperature of the overall metal solution. For example, adding 4-5 % atomic of tin to magnesium reduces the melting temperature of the magnesium-tin solution by about 100° C. relative to pure magnesium. It should be noted that magnesium does not form carbides (e.g., a graphite crucible may be used) and is inexpensive.

Molten media 410 provides a large surface area for reaction (by bubbling the gas from the enclosed environment 308 through the molten media 410, like a sparger, ensuring efficient removal of oxygen. Specifically, the oxygen-getter unit 400 may comprise a gas delivery component 440 comprising a porous core 441 and a non-porous shell 442, e.g., as shown in FIG. 4B. The non-porous shell 442 may be formed from one or more materials selected from the group consisting of ceramic and carbon. The porous core 441 may be formed from porous ceramic, carbon sponges/carbon foam, carbon fibrous insulation, and other materials. The reaction surface area depends on the bubble sizes (e.g., driven by surface tension), positional depth of the porous core 441 in the molten media 410, and speed of bubble flow through the molten media 410 (e.g., driven by the viscosity).

Referring to FIG. 4A, the molten media 410 may be contained in a crucible 420 (e.g., formed from ceramics, graphite, or castable cement) positioned on a heater 430. The heater 430 is used to maintain the desired temperature of the molten media 410 while the gas is supplied through the gas delivery component 440 into the molten media 410 and is bubbled through the molten media 410.

The molten media 410 may be maintained at a temperature of 500-1500° C. during the operation of the battery unit 200 or, more specifically, 700-1200° C. The temperature depends on the kinetics and thermodynamics of the reaction between the molten media 410 and oxygen to form an oxide 412. For example, increasing the temperature increases the oxidation kinetics but, at some point, may also increase the rate of oxidative dissociation reactions.

FIG. 4C is a schematic cross-sectional view of an energy storage system 100 illustrating a passthrough 313 provided in the wall of a low-oxygen enclosure unit 300 for replacing the media 410 in the oxygen-getter unit 400, in accordance with some examples. Furthermore, FIG. 4C illustrates an oxygen-getter enclosure 413, which is configured to controllably isolate the oxygen-getter unit 400 or, more specifically, the environment around the oxygen-getter unit 400 from the rest of the enclosed environment 308 in the low-oxygen enclosure unit 300, e.g., when replacing the media 410 in the oxygen-getter unit 400. Specifically, as the molten media 410 removes oxygen from the enclosed environment 308, the active components (e.g., metals) oxidize and need to be periodically replaced. However, accessing the enclosed environment 308 (e.g., opening the main access door and walking in) without significantly increasing the oxygen content in the enclosed environment 308 is difficult. As such, an oxygen-getter enclosure 413 can be formed proximate a side walls comprising a passthrough 313. When the media 410 needs to be replaced, the oxygen-getter enclosure 413 is reconfigured to seal the local environment (around the oxygen-getter unit 400) from the rest of the enclosed environment 308. The passthrough 313 is then opened, the media 410 is replaced through the passthrough 313 and without anyone entering the enclosed environment 308. The passthrough 313 is sealed thereafter. The local environment (defined by the oxygen-getter enclosure 413) may be then purged before reactivating the oxygen-getter unit 400, e.g., by melting the media 410 and bringing the molten media 410 to the operating temperature and, thereafter, bubbling the surrounding gas through the molten media 410. Once the oxygen level in the local environment approaches the level of that in the rest of the enclosed environment 308, the oxygen-getter enclosure 413 is opened such that the two environments join in and the oxygen-getter unit 400 can remove oxygen from the entire enclosed environment 308. It should be noted that when one oxygen-getter unit 400 is taken offline, one or more additional oxygen-getter units 400 may remain in operation to support the oxygen level in the enclosed environment 308.

### FIG. 5a-5b: Partitioning Examples

FIGS. 5A and 5B are schematic side and top cross-sectional views of a partitioning wall 320 in a low-oxygen enclosure unit 300, in accordance with some examples. The partitioning wall 320 is configured to fluidically isolate a first section 301 and a second section 302 of the low-oxygen enclosure unit 300 from each other. Specifically, the top view in FIG. 5B illustrates four sections of the low-oxygen enclosure unit 300, i.e., a first section 301, a second section 302, a third section 303, and a fourth section 304. The first section 301 is adjacent to both the second section 302 and the third section 303 and is fluidically isolated from both of these sections by the partitioning wall 320 (when the partitioning wall 320 is configured to seal off the sections). This allows separating the first enclosed environment 308a of the first section 301 from the second enclosed environment 308b of the second section 302 and the third enclosed environment 308c of the third section 303. For example, an exterior door may be opened to the first section 301 thereby joining the first enclosed environment 308a and the external environment 309. Furthermore, different sections may have different inert gases, e.g., to enable different operations in different parts of the low-oxygen enclosure unit 300.

Referring to FIG. 5B, the partitioning wall 320 allows different enclosed environments to be fluidically coupled, e.g., by forming openings in the partitioning wall 320. For example, a portion of the partitioning wall 320 extending between the third enclosed environment 308c and the fourth enclosed environment 308d has an opening, forming a fluidic coupling between these two enclosed environments. Similarly, a portion of the partitioning wall 320 extending between the second enclosed environment 308b and the fourth enclosed environment 308d has an opening, forming a fluidic coupling between these two enclosed environments. This fluidic coupling allows to sharing of various units (e.g., dehumidifier 340, internal pressurization unit 360) among different enclosed environments.

At the same time, partitioning out/isolating a first enclosed environment from a second enclosed environment allows maintaining operations in the second enclosed environment (e.g., while accessing the first enclosed environment, e.g., to service a battery unit provided therein). Furthermore, partitioning out/isolating a first enclosed environment from a second enclosed environment allows using different gases (helium (He), argon (Ar), nitrogen (N₂), and/or krypton (Kr)) in different enclosed environments. For example, helium may be more beneficial for battery units operating at high voltages since helium has a higher breakdown voltage and, as such, is less prone to arcing. Krypton may be useful in some environments due to its lower thermal conductivity. Nitrogen may be useful in some environments due to its lower cost.

In some examples, internal battery partitioning wall 322 may be used to fluidically isolate different sections within the battery unit 200. For example, krypton (Kr) may be used in a power block portion of a thermal battery because of its low thermal conductivity. However, krypton (Kr) may be too expensive to fill the entire low-oxygen enclosure unit 300.

In some examples, the low-oxygen enclosure unit 300 or, more specifically, the internal battery partitioning wall 322 may include a gas seal formed from compacted carbon powder. This type of seal is capable is withstanding temperatures exceeding 1500° C., exceeding 2000° C., or even exceeding 2500° C. thereby allowing the separation of two gas environments, one or both of which are maintained at such high temperatures. For example, a compacted carbon powder seal can be used to isolate heaters in the helium-containing environment thereby allowing the operation of these heaters at much higher voltages (than in the argon-containing environment). As a reference, the breakdown voltage of the pure helium gas is >100 V at 2500K, while that of the pure argon gas is <10 V when the separation is ˜0.25 inches.

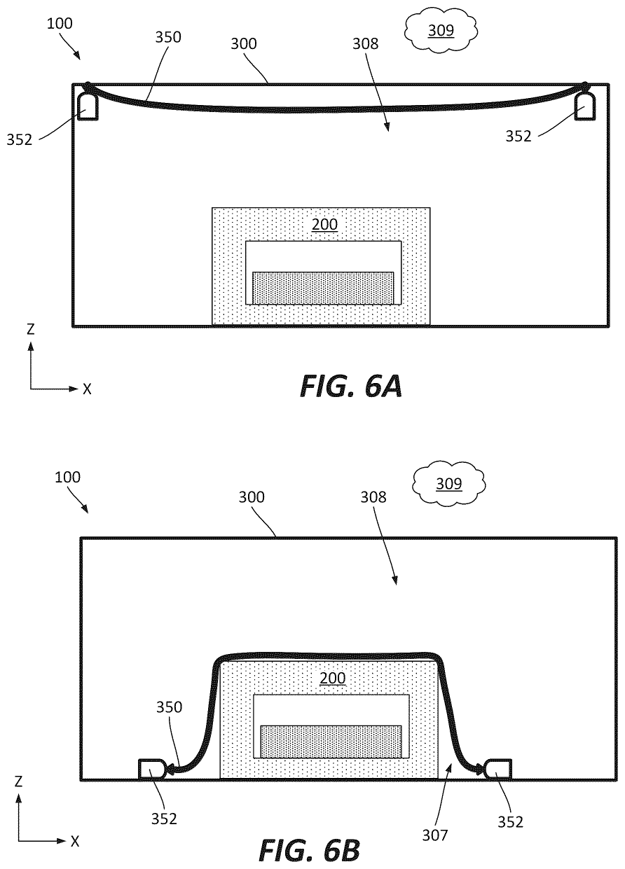

### FIG. 6a-6b: Fire Suppression Examples

FIGS. 6A and 6B are schematic cross-sectional views of the energy storage system 100 or, more specifically, the low-oxygen enclosure unit 300 before and after deploying an oxygen-blocking cover 350 to cover the battery unit 200, in accordance with some examples. Specifically, the low-oxygen enclosure unit 300 may comprise an oxygen-blocking cover 350 suspended above the battery unit 200 and configured to drop and conform to the battery unit 200 when released thereby blocking air or, more specifically, oxygen from reaching various components inside the battery unit 200 (e.g., components heated to a temperature much higher than the environment). It should be noted that components of the battery unit 200 that come in contact with the oxygen-blocking cover 350 may not be excessively hot (e.g., tarp-like covers, plastic sheets, and other like structures may be used as an oxygen-blocking cover 350).

The oxygen-blocking cover 350 may additionally isolate the enclosed environment 308 from the battery unit 200, e.g., when the enclosed environment 308 is compromised during the operation of the battery unit 200 when the battery unit 200 malfunctions.

An oxygen-blocking cover 350 is made from materials that are highly resistant to fire and heat, such as fiberglass (fine strands of glass woven into a fabric), silica fabric (woven silica fibers), and/or other like materials. In some examples, the material of an oxygen-blocking cover 350 may be treated with a flame retardant and used as a means of fire suppression in the event the enclosure is damaged.

The edges of the oxygen-blocking cover 350 may be connected to weight units 352 to help the oxygen-blocking cover 350 to descend to and over the battery unit 200 and conform to the shape of the battery unit 200. For example, sandbags, metal blocks, or other weights may be used for such purposes.

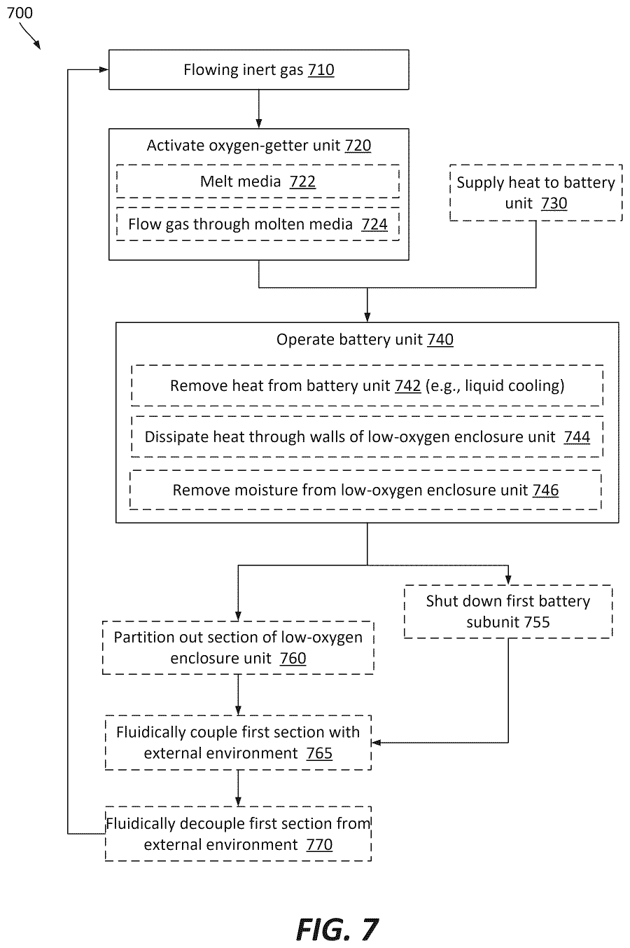

### FIG. 7: Operating Examples

FIG. 7 is a process flowchart corresponding to method 700 of operating an energy storage system 100, in accordance with some examples. Various aspects of the energy storage system 100 are described above (e.g., an energy storage system 100 comprising a battery unit 200 and a low-oxygen enclosure unit 300 surrounding the battery unit 200 and comprising an oxygen-getter unit 400).

In some examples, method 700 comprises (block 710) flowing an inert gas into low-oxygen enclosure unit 300 until an oxygen concentration in the low-oxygen enclosure unit 300 falls below the first threshold. This operation may be referred to as purging of the low-oxygen enclosure unit 300 with inert gas. Some examples of inert gases are argon (Ar), nitrogen (N₂), helium (He), and krypton (Kr). Argon (Ar) may be particularly suitable due to its costs and inertness to various components within the low-oxygen enclosure unit 300 that may reach high temperatures during their operations (e.g., as high as 3500° C.).

During this purging operation, the low-oxygen enclosure unit 300 forms an enclosed environment 308 separated by the low-oxygen enclosure unit 300 from an external environment 309 such that the battery unit 200 is positioned with the enclosed environment.

Improving the purging efficiency allows reducing the number of purge cycles and/or reducing the first threshold, both of which are highly beneficial. One consideration is gas flow rates and positions of the inlet and outlets (e.g., creating or minimizing stagnant areas), specific purging techniques (e.g., displacement purging, dilution purging, reduced/elevated pressure purging, and the like), purge gas composition, purge gas temperature, staged purging (e.g., using a partitioning wall 320 to isolate different sections), and the like.

In some examples, method 700 comprises (block 720) activating the oxygen-getter unit 400 thereby further reducing the oxygen concentration in the low-oxygen enclosure unit 300 below a second threshold, lower than the first threshold, and lower than 500 ppm, lower than 100 ppm, or even lower than 10 ppm. This may be referred to as an oxygen-getting operation and/or a second stage of the oxygen-reduction process.

Specifically, (block 720) activating the oxygen-getter unit 400 may comprise (block 722) melting a media in the crucible 420. Various examples of the media and other aspects of the oxygen-getter unit 400 are described above with reference to FIGS. 4A and 4B. The oxygen-getting operation/(block 720) activating the oxygen-getter unit 400 may further comprise (block 724) flowing a gas contained in the low-oxygen enclosure unit 300 and surrounding the battery unit 200 through the molten media 410. As noted above, the molten media 410 may be maintained at a temperature of 500-2000° C. or, more specifically, 500-1500° C.

In some examples, the method 700 comprises (block 740) operating the battery unit 200 while the oxygen concentration in the low-oxygen enclosure unit 300 is maintained below the second threshold.

In some examples, low-oxygen enclosure unit 300 comprises a wall 310 separating the enclosed environment 308 from the external environment 309. In these examples, (block 740) operating the battery unit 200 inside the low-oxygen enclosure unit 300 comprises (block 744) dissipating heat through the walls of low-oxygen enclosure unit 300 from the enclosed environment to the external environment.

In some examples, (block 740) operating the battery unit 200 inside the low-oxygen enclosure unit 300 comprises (block 746) removing moisture from the enclosed environment.

In some examples, method 700 further comprises (block 760) partitioning out a first section 301 of the low-oxygen enclosure unit 300 from a second section 302 of the low-oxygen enclosure unit 300. For example, the battery unit 200 comprises a first battery subunit 200a positioned in the first section 301 and a second battery subunit 200b positioned in the second section 302. In more specific examples, method 700 further comprises, after (block 760) partitioning out the first section 301, (block 765) fluidically coupling the first section 301 with the external environment 309. Furthermore, method 700 may comprise, prior to (block 765) fluidically coupling the first section 301 with the external environment 309, shutting down the first battery subunit 200a.

In some examples, the second battery subunit 200b continues to operate while the first section 301 is fluidically coupled with the external environment 309.

### Conclusion

Although the foregoing concepts have been described in some detail for purposes of clarity of understanding, it will be apparent that certain changes and modifications may be practiced within the scope of the appended claims. It should be noted that there are many alternative ways of implementing processes, systems, and apparatuses. Accordingly, the present embodiments are to be considered illustrative and not restrictive.

1. An energy storage system comprising:
a battery unit, which has a total energy-storage capacity of at least 1 MWh; and
a low-oxygen enclosure unit, which forms an enclosed environment that is fluidically isolated from an external environment by the low-oxygen enclosure unit during operation of the battery unit, wherein:
the enclosed environment has a volume of at least 50 m³ and surrounds the battery unit while an oxygen concentration in the enclosed environment is less than 500 ppm during the operation of the battery unit, and
the low-oxygen enclosure unit comprises an oxygen-getter unit of one or more types selected from the group consisting of a molten-media oxygen-getter unit, a solid-based oxygen-getter unit, and a gas-based oxygen-getter unit.

2. The energy storage system of claim 1, wherein the oxygen-getter unit is the molten-media oxygen-getter unit comprising one or more elements selected from the group consisting of magnesium, tin, zirconium, titanium, iron, aluminum, zinc, and silicon that form a molten media during the operation of the battery unit.

3. The energy storage system of claim 2, wherein the molten media is configured to operate at a temperature of 500-2000°C during the operation of the battery unit.

4. The energy storage system of claim 2, wherein the oxygen-getter unit further comprises a gas delivery component comprising a porous core and a non-porous shell formed from one or more materials selected from the group consisting of ceramic and carbon.

5. The energy storage system of claim 2, wherein the low-oxygen enclosure unit comprises an exterior wall separating the enclosed environment from the external environment comprising a passthrough for accessing the oxygen-getter unit from the external environment.

6. The energy storage system of claim 5, wherein the low-oxygen enclosure unit comprises an oxygen-getter enclosure configured to controllably isolate a local environment surrounding the oxygen-getter unit from a remaining portion of the enclosed environment.

7. The energy storage system of claim 1, wherein the low-oxygen enclosure unit comprises one or more additional oxygen-getter units positioned in different parts of the enclosed environment and away from the oxygen-getter unit.

8. The energy storage system of claim 1, wherein:
the low-oxygen enclosure unit comprises an exterior wall separating the enclosed environment from the external environment,
the exterior wall comprises a metal sheet or a polymer sheet forming both an interior wall surface and an exterior wall surface,
the interior wall surface faces and is exposed to the enclosed environment, and
the exterior wall surface faces and is exposed to the external environment.

9. The energy storage system of claim 1, wherein the low-oxygen enclosure unit comprises a partitioning wall, which is configured to fluidically isolate a first section of the low-oxygen enclosure unit from a second section of the low-oxygen enclosure unit.

10. The energy storage system of claim 1, wherein the low-oxygen enclosure unit comprises an electrochemical-oxygen sensor for determining the oxygen concentration of the enclosed environment.

11. The energy storage system of claim 1, wherein the low-oxygen enclosure unit comprises a dehumidifier for removing moisture from the enclosed environment generated while heating the battery unit.

12. The energy storage system of claim 1, wherein the low-oxygen enclosure unit comprises an oxygen-blocking cover suspended above the battery unit and configured to drop and conform to the battery unit when released.

13. The energy storage system of claim 1, wherein the low-oxygen enclosure unit comprises an internal pressurization unit configured to maintain the enclosed environment at a higher pressure than the external environment.

14. The energy storage system of claim 13, wherein the internal pressurization unit is configured to supply inert gas to the enclosed environment based on a pressure difference between the enclosed environment and the external environment.

15. The energy storage system of claim 14, wherein the inert gas is selected from the group consisting of nitrogen, argon, neon, helium, xenon, and krypton.

16. The energy storage system of claim 1, further comprising an external liquid cooling system positioned in the external environment and comprising a set of pipes protruding through and into the low-oxygen enclosure unit and thermally coupled to the battery unit.

17. The energy storage system of claim 1, wherein the battery unit is a thermal battery comprising a battery core and a battery insulation surrounding the battery core and thermally isolating the battery core from the enclosed environment such that the battery core is configured to operate at a temperature of at least 1000°C.

18. The energy storage system of claim 17, wherein the battery core further comprises a storage unit, a piping infrastructure, and a power block such that the piping infrastructure is configured to pump a molten metal between the storage unit and the power block.

19. The energy storage system of claim 17, wherein the battery core is configured to operate at a temperature of at least 1000°C.

20. A method of operating an energy storage system comprising a battery unit and a low-oxygen enclosure unit surrounding the battery unit and comprising an oxygen-getter unit, the method comprising:
flowing an inert gas into the low-oxygen enclosure unit until an oxygen concentration in the low-oxygen enclosure unit falls below a first threshold, wherein the low-oxygen enclosure unit forms an enclosed environment separated by the low-oxygen enclosure unit from an external environment such that the battery unit is positioned with the enclosed environment;
activating the oxygen-getter unit thereby further reducing the oxygen concentration in the low-oxygen enclosure unit below a second threshold, lower than the first threshold and lower than 500 ppm; and
operating the battery unit while the oxygen concentration in the low-oxygen enclosure unit is maintained below the second threshold.
